(19) United States
(12) Patent Application Publication
(10) Pub. No.: US 2002/0179399 A1
(43) Pub. Date: Dec. 5, 2002

(54) Thrust plate assembly

(75) Inventors: Hartmut Bach, Schweinfurt (DE); Cora Carlson, Dittelbrunn (DE); Matthias Dorfler, Schweinfurt (DE); Gunther Esly, Wasserlosen (DE); Reinhard Feldhaus, Niederwerrn (DE); Ingrid Hoffelner, Knetzgau (DE); Christoph Kleuker, Springe (DE); Paul Kraus, Niederwerrn (DE); Andreas Orlamunder, Schweinfurt (DE); Bernd Peinemann, Niederwerrn (DE); Michael Peterseim, Oberdorla (DE); Gerhard Roll, Eisenheim (DE); Ralf Till, Euerbach (DE); Sebastian Vogt, Bad Neustadt (DE); Andreas Dau, Wurzburg (DE)

Correspondence Address: Thomas C. Pontani, Esq., Cohen, Pontani, Lieberman & Pavane, Suite 1210, 551 Fifth Avenue, New York, NY, 10176, US

(73) Assignee: ZF Sachs AG

(21) Appl. No.: 10/160,150

(22) Filed: May 30, 2002

(30) Foreign Application Priority Data
Jun. 1, 2001 (DE) 101 26 779.7

(51) Int. Cl. F16D 13/71

(52) U.S. Cl. 192/70.28; 192/89.22

(57) ABSTRACT

A pressure plate is held in a housing so as to be movable in direction of an axis of rotation (A) and is acted upon or can be acted upon by an energy accumulator. The pressure plate is coupled with the housing by at least one coupling arrangement which acts upon the pressure plate axially during torque transmission. The thrust plate assembly further comprises a lifting force generating arrangement for generating a lifting force for the pressure plate.

### BACKGROUND OF THE INVENTION

1. Field of the Invention

The present invention is directed to a thrust plate assembly comprising a housing arrangement and a pressure plate arrangement which is held in the housing arrangement so as to be movable in direction of an axis of rotation and which is acted upon or can be acted upon by an energy accumulator, the pressure plate arrangement being coupled with the housing arrangement by a coupling arrangement which acts upon the pressure plate arrangement axially during torque transmission.

2. Description of the Related Art

Thrust plate assemblies of the type mentioned above are constructed in the area of the coupling arrangements, for example, such that leaf spring elements which are curved in axial direction are used in the latter. During transmission of torque and the rotational loading of the pressure plate arrangement with respect to the housing arrangement which is entailed by it, these leaf spring elements tend to stretch in circumferential direction and, in so doing, lead to an increased axial pressing of the pressure plate arrangement against the friction linings of a clutch disk. It is also known to provide supporting projections which project radially outward or to provide cams at the pressure plate which are displaceable along associated supporting surfaces of the housing arrangement, which supporting surfaces are inclined relative to a plane orthogonal to the axis of rotation. Thus, a ramp surface arrangement is provided which ensures a movement deflection or force deflection in axial direction during the above-mentioned transmission of torque and introduction of force. Regardless of which of these arrangements is used to achieve a self-reinforcement effect when pressing force is generated, it is advantageous that the coupling arrangements can be constructed merely so as to be optimized with respect to the pressing force reinforcement effect. However, particularly in arrangements using the leaf spring elements mentioned above, these leaf spring elements, because of their corresponding pretensioned installation, generally generate a lifting force in addition in order to be able to move the pressure plate arrangement away from the clutch disk axially in the release state or during the transition to the release state. This lifting force is opposed to the force component contributing to the reinforcement of pressing force and accordingly reduces the self-reinforcing effect.

### SUMMARY OF THE INVENTION

It is the object of the present invention to provide a thrust plate assembly which provides for the generation of a lifting force in a suitable manner simultaneous with an optimal pressing force reinforcement effect.

According to the present invention, the thrust plate assembly includes a lifting force generating arrangement for generating a lifting force for the pressure plate arrangement. By decoupling the functions of pressing force reinforcement and lifting force generation, each of the areas provided therefor can be constructed in optimal manner.

For example, the pressure plate arrangement can be coupled with the energy accumulator for common movement in the releasing direction by the lifting force generating arrangement. For this purpose, in a variant which is particularly simple to construct and which operates in reliable fashion, the lifting force generating arrangement at the pressure plate arrangement comprises a driving arrangement which overlaps the energy accumulator in its radial outer area. For this purpose, the driving arrangement can comprise at least one driving element which is secured to the pressure plate arrangement. This driving element can be formed in one piece with a leaf spring element of the coupling arrangement, for example.

In an alternate embodiment form of the thrust plate assembly according to the invention, the driving arrangement forms an undercut in axial direction and the energy accumulator is positioned or can be positioned so as to engage in the undercut by a radial expansion of the energy accumulator occurring during an assembly process and/or by rotational movement of the energy accumulator with respect to the pressure plate.

In order to realize the cooperation of the different components for lifting force generation in an arrangement of the type mentioned above in a simple and dependable manner, it is suggested that the driving arrangement comprises a plurality of successive driving areas in circumferential direction and that the energy accumulator has a plurality of driver tongues in its radial outer area which are positioned or can be positioned in undercuts formed in the driving areas by means of the rotation of the energy accumulator with respect to the pressure plate.

According to another alternate embodiment form, at least one driver hook can be provided at a radial outer area of the energy accumulator, which driver hook engages, preferably from the radial outer side, in an undercut provided at the pressure plate arrangement. The driver hook can be formed integral with the energy accumulator, for example, but can also be provided at a driver ring which is provided at the radial outer area of the energy accumulator.

In another alternate embodiment form of the thrust plate assembly according to the invention, the coupling arrangement has at least one coupling lever element which is connected with the pressure plate arrangement and the housing arrangement so as to be pivotable about respective pivot axes, and the at least one coupling lever element is pretensioned by the lifting force generating arrangement so as to pivot about at least one of the pivot axes. In order to realize the pivoting pretensioning, the lifting force generating arrangement can have a spring element which pretensions the at least one coupling lever element for pivoting movement and which can be a leg spring, for example, wherein one of the spring legs of the leg spring is supported with respect to the coupling lever element and another spring leg of the leg spring is supported with respect to an arrangement of the housing arrangement and pressure plate arrangement.

In an alternate embodiment form which is advantageous in view of its small number of parts, the spring element is constructed integral with the at least one coupling lever element. This can be achieved, for example, in that the at least one coupling lever element is U-shaped, in that the coupling lever element is supported by a connecting web connecting the two U-legs at an arrangement of the housing arrangement and pressure plate arrangement so as to be pivotable, in that one of the U-legs is supported in an area of thereof remote of the connecting web at the other arrangement of the pressure plate arrangement and housing arrangement so as to be pivot, and in that the other U-leg is supported at one arrangement for generating the pretensioning force.

According to another alternate embodiment form, the lifting force generating arrangement includes at least one spring element which is constructed so as to be substantially independent from the coupling arrangement with respect to its lifting force generating characteristic. In so doing, it is possible, for example, that the spring element comprises a helical compression spring element, helical tension spring element, leaf spring element, scroll spring element or the like acting between the pressure plate arrangement and the housing arrangement. Due to the small number of parts, it can advantageously be provided that the coupling arrangement comprises at least one leaf spring element and that the lifting force generating arrangement comprises a spring element which is formed in one piece with the at least one leaf spring element of the coupling arrangement.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial longitudinal section through a friction clutch;

FIG. 2 is a schematic axial view of the pressure plate of the friction clutch shown in FIG. 1, which pressure plate is coupled with a housing arrangement;

FIG. 3 shows the principle of operation of a clutch with self-reinforcing action;

FIG. 4 shows a detail of a first construction of a lifting force generating arrangement according to the invention in section along a line IV-IV in FIG. 5;

FIG. 5 shows a top view of the arrangement in FIG. 4;

FIG. 6 is a view of the arrangement in FIG. 4 in viewing direction VI in FIG. 5;

FIG. 7 is a view corresponding to FIG. 4 showing an alternate construction type of the lifting force generating arrangement;

FIG. 8 is another view corresponding to FIG. 4 showing an alternate construction type of the lifting force generating arrangement;

FIG. 9 shows a top view of an energy accumulator used in the embodiment form according to FIG. 8;

FIG. 10 is a sectional view through the energy accumulator shown in FIG. 9 along a line X-X in FIG. 9;

FIG. 11 is a view corresponding to FIG. 9 showing an alternate construction of the energy accumulator;

FIG. 12 shows a sectional view of the energy accumulator shown in FIG. 11 along a line XII-XII in FIG. 11;

FIGS. 13-15 show different phases of the assembly of a thrust plate assembly according to the invention for realizing a further constructional variant of a lifting force generating arrangement;

FIG. 16 shows a partial top view of an alternate construction of an lifting force generating arrangement according to the invention;

FIG. 17 shows a driving element used in the embodiment form according to FIG. 16;

FIG. 18 shows a sectional view of the arrangement shown in FIG. 16 along a line XVIII-XVIII in FIG. 16;

FIG. 19 shows a sectional view of the arrangement shown in FIG. 16 along a line XIX-XIX in FIG. 16;

FIG. 20 shows a view of another alternate construction of a thrust plate assembly according to the invention, considered from the radial outside;

FIG. 21 shows a partial top view of the thrust plate assembly shown in FIG. 20;

FIG. 22 shows an enlarged detail of the thrust plate assembly shown in FIG. 20 from the radial outside;

FIG. 23 shows a top view of the detail shown in FIG. 22;

FIG. 24 shows an alternate construction of a coupling lever element;

FIG. 25 shows a detail, corresponding to FIG. 23, of an alternate construction of a coupling lever element;

FIG. 26 is a side view of the coupling lever element shown in FIG. 5; and

FIGS. 27-30 show other alternate constructions of lifting force generating arrangements in a thrust plate assembly.

### DETAILED DESCRIPTION OF THE PRESENTLY PREFERRED EMBODIMENTS

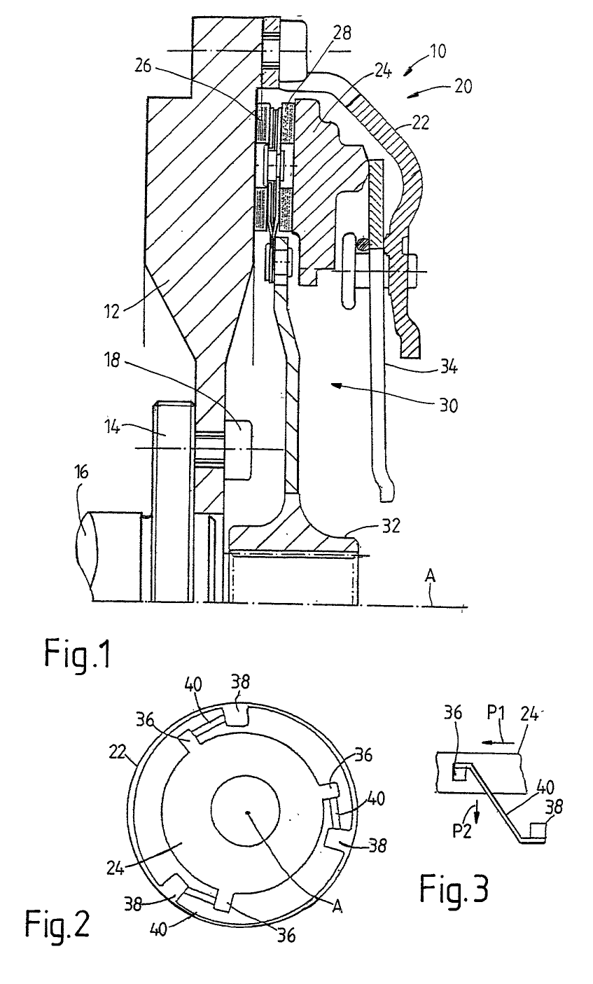

The basic construction of a friction clutch 10 in which the inventive principles are or can be realized is shown in FIGS. 1 and 2. The friction clutch 10 comprises a flywheel 12 which can be constructed, for example, as a dual-mass flywheel, which is secured in the radial inner area to a crankshaft flange 14 of a crankshaft 16 or some other drive shaft by a plurality of screw bolts 18. In its radial outer area, the flywheel 12 is fixedly connected with a thrust plate assembly 20. The thrust plate assembly 20 comprises a housing 22 and a pressure plate 24 which is axially displaceable in the housing 22 but which is held so as to be substantially fixed with respect to rotation relative to the housing 22. The friction facings 26, 28 of a clutch disk 30 are located between the pressure plate 24 and the flywheel 12. This clutch disk 30 can be coupled in its radial inner hub area 32 with a driven shaft, for example, a transmission input shaft, so as to be fixed with respect to rotation relative to it. The pressure plate 24 is pretensioned basically in the direction of the flywheel 12 by an energy accumulator 34, for example, a diaphragm spring. In the present example, the clutch 10 is a push-type clutch.

As is shown in FIG. 2, coupling portions 36 and 38, respectively, are provided at the pressure plate 24 and at the housing arrangement 22 or, as the case may be, also at the flywheel 12. One of the coupling portions 36 and one of the coupling portions 38 are connected with one another by a coupling arrangement 40 extending approximately in circumferential direction. These coupling arrangements 40 are formed of flexible elements so that, in principle, an axial movement of the pressure plate 24 is possible for carrying out engagement and release processes. When the coupling portions 36, 38 are offset relative to one another in direction of the axis of rotation as is illustrated in FIG. 3 and the coupling arrangements 40 extend in the manner shown in FIG. 3, an application of force of the pressure plate 24 in circumferential direction with respect to the housing arrangement 22 in the direction indicated by the arrow P₁, which occurs, for example, in pull operation, results in a deflection of force due to lever ratios and leads to a reinforcement of the pressing force exerted on the friction facings 28, 26 by the pressing force 24, which reinforcement is directed as indicated by arrow P₂. In this type of clutch 10 with a self-reinforcing effect, it is possible to achieve pressing forces which are fundamentally higher than those that can be attained by conventional diaphragm springs while still allowing actuation. If an extremely high pressing force is not required, it is possible to provide the diaphragm spring and the energy accumulator 34 with lower pressing force capacity so that smaller release forces are also required.

It should be noted that only the basic construction of a friction clutch with self-reinforcing effect has been described thus far. Of course, a wide range of changes can be implemented in a clutch of this kind whether or not the principles of the present invention are applied, e.g., providing a wear compensating arrangement, a multi-mass flywheel as was already mentioned, a torsional vibration damper in the area of the clutch disk, and so on.

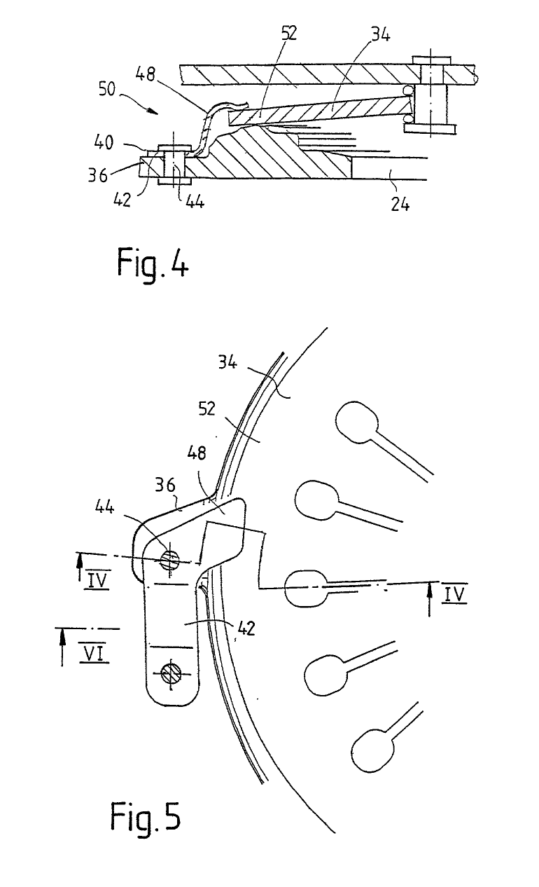

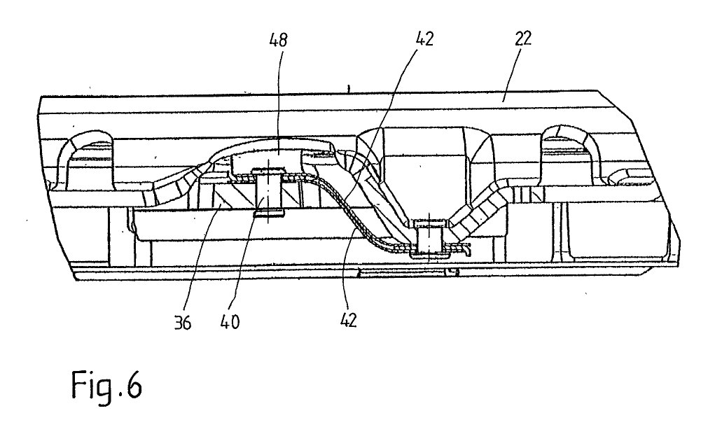

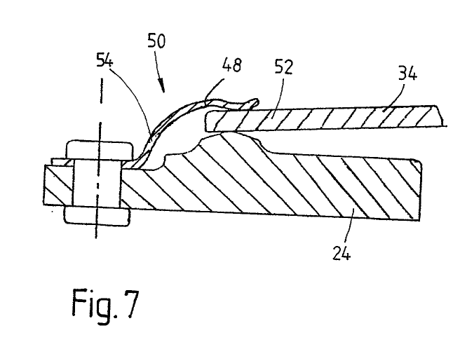

A first embodiment form of a lifting force generating arrangement 50 will be described in the following with reference to FIGS. 4 to 6. It will be seen that the different coupling arrangements 40 can comprise, for example, leaf spring elements 42 or even a plurality of leaf spring elements 42 stacked one upon the other (see FIG. 6). In their end areas which are secured to the pressure plate 24 by means of rivet studs 44, for example, the leaf spring elements 42 or at least one element of a leaf spring stack have or has a projection 48 which projects radially inward. As can be seen from FIG. 4, this projection 48 is bent or curved axially and overlaps the radial outer area 52 of the energy accumulator 34. In this way, the pressure plate 24 is fixedly held at the energy accumulator 34 at a plurality of areas situated in circumferential direction. When the energy accumulator 34 is moved radially inward toward the flywheel 12 in the present example of a push-type clutch, it moves radially outward, that is, with a radial outer area 52 in the direction away from the flywheel and, in so doing, carries along the pressure plate 24 because of the projections 48 providing the fixed hold. Therefore, no further steps need be provided for generating the lifting force. In particular, the leaf spring elements 42 need not be installed with pretensioning such that they themselves provide for the generation of the lifting force. In the modification of this embodiment form shown in FIG. 7, for example, separate holding elements 54 can be provided for generating this holding action and can have the projection 48 projecting radially inward in order to engage behind the radial outer area 52 of the energy accumulator 34. Accordingly, this construction is not only fully independent from the force characteristic or effective operation of the leaf springs 42, but is also fully independent from the positioning of these leaf springs.

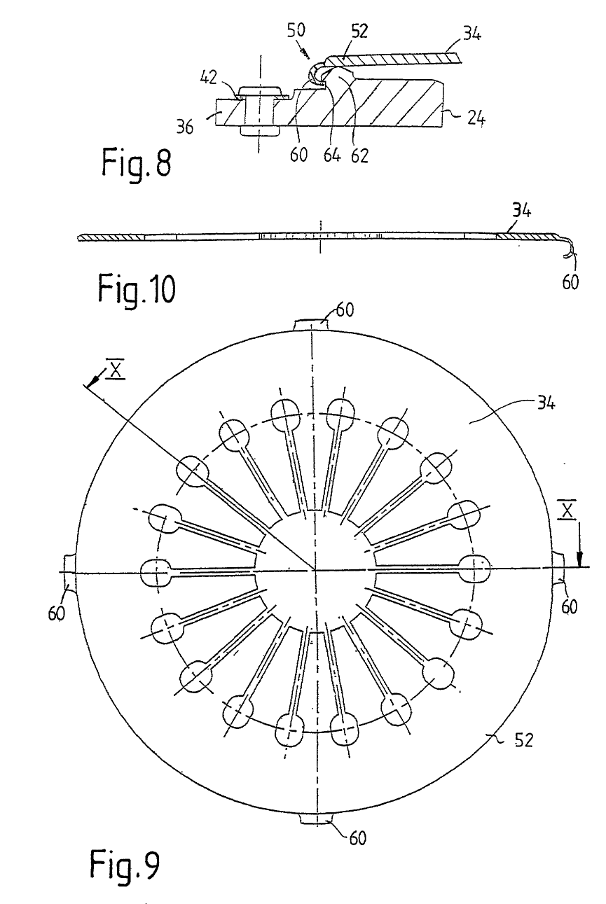

An alternate variant of a lifting force generating arrangement 50 is described in the following with reference to FIGS. 8 to 12. First, it will be seen in FIGS. 8 to 9 that a plurality of hook-like driver projections 60 are formed at the radial outer area 52 of the energy accumulator 34 at a plurality of circumferential positions. A groove-like undercut 64 is formed on the radial outside at the knife edge area 62 of the pressure plate 24 serving to support the energy accumulator 34, the hook-like driver projections 60 engaging in this groove-like undercut 64 in the assembled state, for example, by snapping in. Therefore, the above-mentioned fixed coupling of the pressure plate 24 with the energy accumulator 34 is again produced with the result that the pressure plate 24 is also compulsorily moved away axially from the clutch disk when the releasing movement of the energy accumulator 34 is carried out.

The hook-like projections can be produced by shaping or deformation of the spring steel blank used for producing the energy accumulator 34. In this case, a reduction in the material thickness can first be achieved in the corresponding areas by rolling, for example, in order to facilitate deformability.

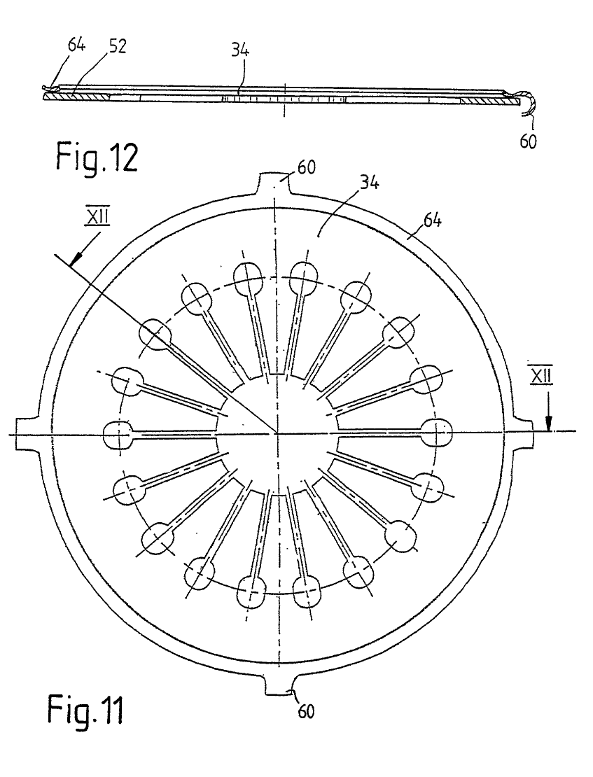

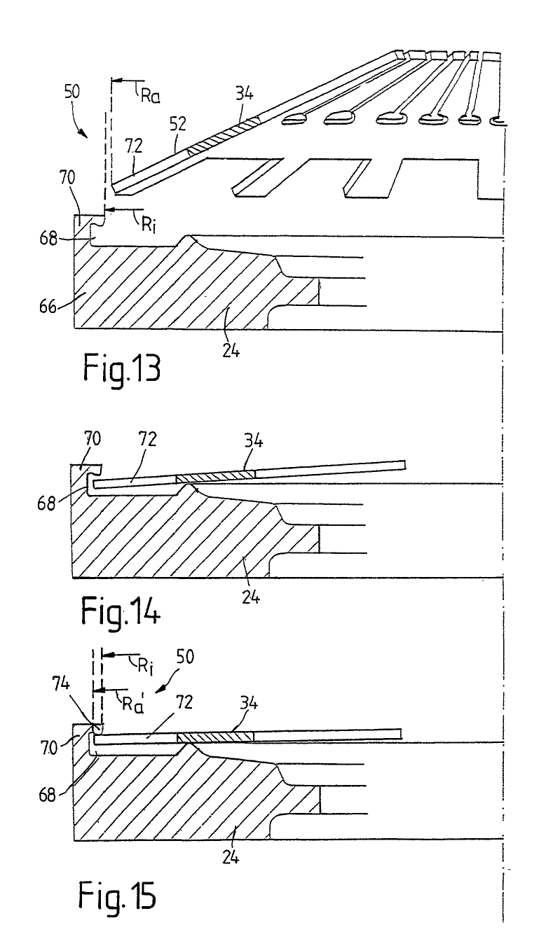

In the variant shown in FIGS. 11 and 12, a driver ring 64 is secured, e.g., by welding, riveting or the like, to the energy accumulator 34 in the radial outer area 52. This driver ring 64 now carries the hook-like coupling projections 60. The advantage of this embodiment form is that the material for the driver ring 64 can be selected substantially independently from the material selection for the energy accumulator 34.

Another alternate construction of the fixed coupling of the pressure plate to the energy accumulator for generating the lifting movement is shown in FIGS. 13 to 15. A driving area 70 with an undercut which opens radially inward is formed, for example, integral with the pressure plate 24 in its radial outer area 66 or is formed by one or more structural component parts arranged at the latter, wherein the undercut 68 can be constructed so as to be continuous in circumferential direction, for example. In its radial outer area 52, the energy accumulator 34 has a plurality of driver tongues 72 which project radially outward. FIG. 13 shows the state prior to assembly of the thrust plate assembly. As a result of the shaping of the energy accumulator, this energy accumulator has an outer radius Rₐ in the area of the driver tongues 72 that is slightly smaller than the inner radius Rᵢ of the driving area 70. When the thrust plate assembly is assembled, this energy accumulator 34 is compressed axially in order to achieve the pretensioned installation of the energy accumulator 34 and is accordingly held between the pressure plate 24 and the housing, not shown in FIGS. 13 to 15, for example, at spacer pins provided at the housing. With this flattening of the energy accumulator 34 which takes place in the transition to the state shown in FIG. 14, the radial extension of the energy accumulator 34 is increased with the result that the driver tongues 72 enter into the undercut 68 of the driving area 70 from the radial inner side. Since in this state, as can be seen from FIG. 15, the enlarged outer radius Rₐ′ is now greater than the inner radius Rᵢ of the driving area 70, during the releasing movement in which the energy accumulator 34 becomes even flatter, the energy accumulator 34 comes into contact by its driver tongues 72 with the portion 74 of the driving area 70 projecting radially inward and accordingly carries the pressure plate 24 along axially.

As was already stated, the undercut 68 can be continuous or, if required, interrupted in circumferential direction and the driving area 70 can be provided as a separate structural component part, as a plurality of separate structural component parts or as an integral part of the pressure plate 24.

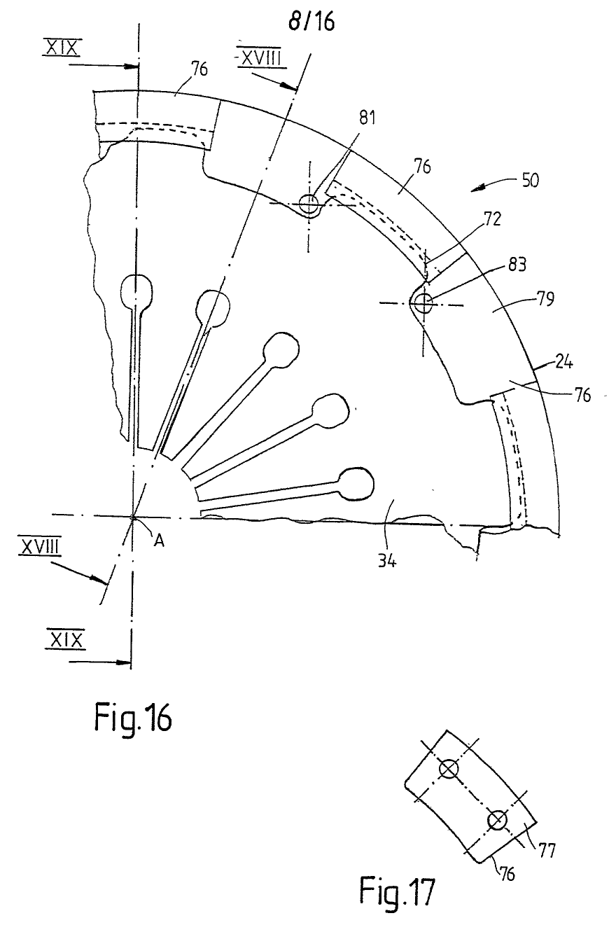

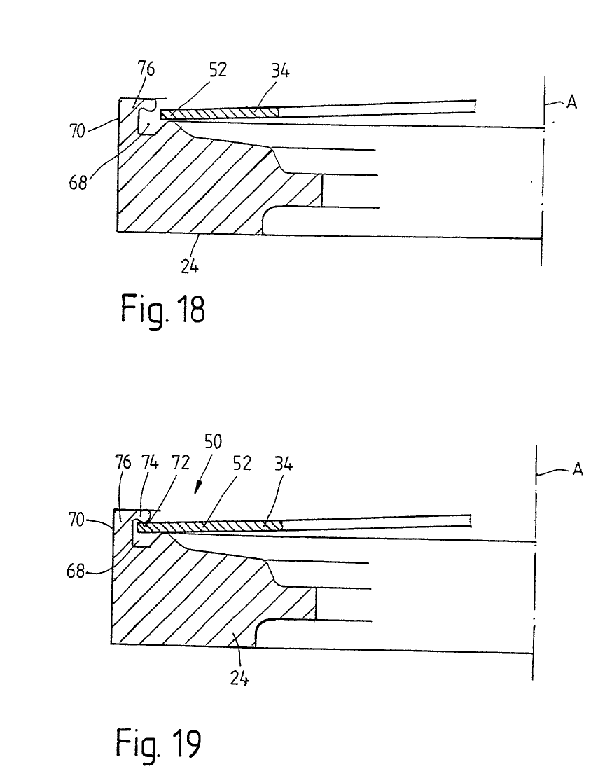

A modification of this construction of a lifting force generating arrangement 50 is shown in FIGS. 16 to 19. In this case, it will be seen that a plurality of driving elements 76 are connected to the pressure plate 24 in the radial outer areas, for example, by means of rivet studs or the like which are guided through respective openings 77. Circumferential cutouts 79 are provided between individual driving elements 76. The energy accumulator 34 has a plurality of driver tongues 72 which project radially outward and which, in the present case, can have a shorter extending length than that previously shown. An undercut 68 is formed in the area of each driving element 76 which, of course, can also be constructed integral with the pressure plate 24 to form the driving area 70 as is shown in FIGS. 18 and 19. In the assembled state, at least one driver tongue 72 engages in an undercut 68 of this kind in order to ensure again that the pressure plate 24 is moved away from the clutch disk in axial direction in a compulsory manner by its radial outer area 52 when the energy accumulator 34 is acted upon in the radial inner area and is held at the housing in the radial middle area. For purposes of assembly, the energy accumulator 34 is positioned with respect to the pressure plate in such a way that its driver tongues 72 enter the cutouts 79. The energy accumulator 34 is then rotated until it occupies the position shown in FIG. 16. Circumferential retaining pins 81, 83 can then be inserted into the pressure plate 24 on both sides of at least one driver tongue 72 so as to prevent a rotation of the energy accumulator 34.

The driving elements 76 can be provided, for example, as shaped sheet metal parts, castings or the like. A further advantage of the embodiment form shown in FIGS. 16 to 19 is the shorter driver tongues, as a result of which an uninterrupted body area of the energy accumulator which is larger in circumferential direction can be provided, so that there is greater freedom in the design of the spring characteristic of the energy accumulator. As a result of the positive guiding of the pressure plate in the embodiment forms described above, vibrations of the pressure plate with respect to the energy accumulator can be prevented particularly in the release process and in the release state.

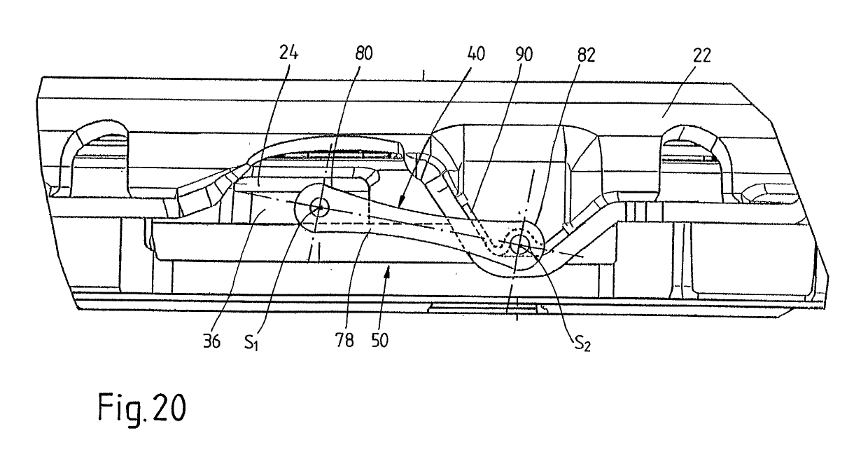

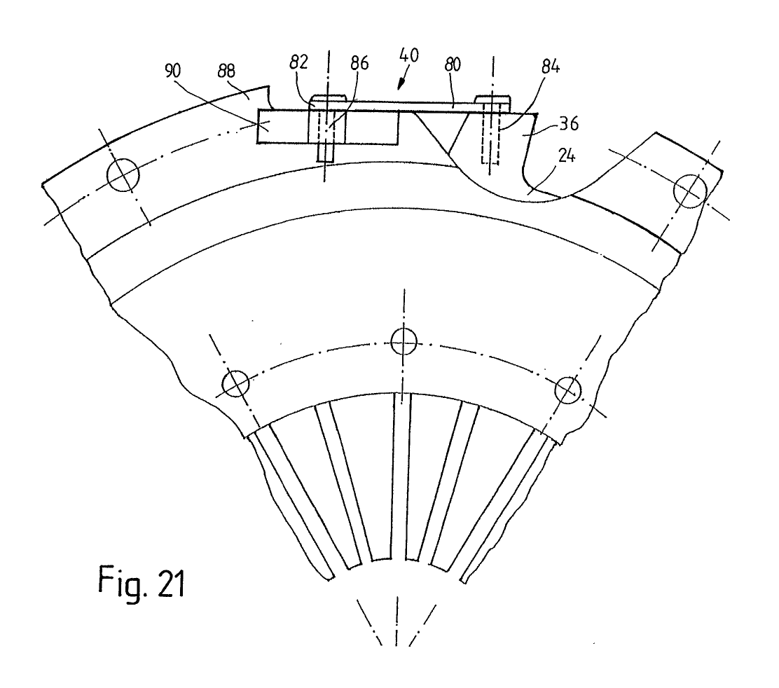

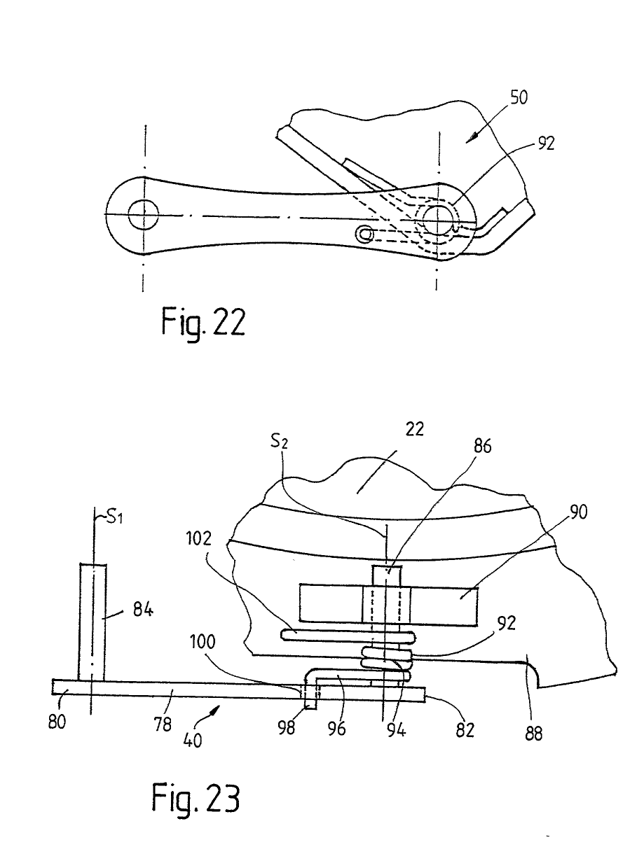

Another type of construction of a thrust plate assembly according to the invention with a lifting force generating arrangement is described with reference to FIGS. 20 to 23. First, it will be seen in FIG. 20 that the coupling arrangements 40 have coupling lever elements 78 in this case. These coupling lever elements 78 are arranged in a first end area at the pressure plate 24 or at a respective coupling portion 36 thereof so as to be pivotable about a pivot axis S₁. In a second end area 82, the coupling lever elements 78 are connected with the housing 22 so as to be pivotable about a second pivot axis S₂. This twofold pivotable connection can be achieved, for example, as can be seen in FIG. 21, in that a pin part or arbor part 84 penetrating the first end area 80 or inserted in the latter is inserted into the coupling portion 36 of the pressure plate 24 from the radial outer side. In the end area 82, a corresponding pin part or arbor part 86 can be held at the housing or at an area 88 thereof which projects radially outward in the manner of a flange by a carrier part 90. The coupling lever elements 78 form tie rods which, as was described above with reference to the bent leaf spring elements, have the tendency when acted upon by the pressure plate 24 in circumferential direction with respect to the housing 22 to stretch or to align their two pivot axes S₁ and S₂ in the direction of the introduction of force. Consequently, as a result of the arrangement of these two pivot axes S₁ and S₂ which is offset fundamentally in axial direction, a reinforcement of the pressing force is achieved. Since the coupling element 78, or each coupling element 78, is preferably freely pivotable in the area of its two pivot axes S₁ and S₂ with respect to the housing 22 and pressure plate 24, no axial forces can be provided in principle for generating the lifting force by means of the coupling lever elements 78 themselves. In order to be able to achieve a lifting force in this arrangement nevertheless, the lifting force generating arrangement 50 has a leg spring 92 which is shown in detail in FIGS. 22 and 23. The leg spring 92 encloses the pin part or arbor part 86 by its body area 94 which is coiled helically. The leg spring 92 is inserted into an opening 100 of the coupling lever element 78 by a first spring leg 96 in the area of a bent end 98 thereof. The leg spring 92 is supported at the flange-like area 88 of the housing 22 by the second spring leg 102. As a result of corresponding tensioned installation of the leg spring 92, it is ensured that the coupling lever element 78 is pretensioned for a pivoting movement about its pivot axis S₂ with respect to the housing 22. It can be ensured in this way that when force is applied by the energy accumulator 34 the pressure plate is moved in the direction away from the clutch disk in a compulsory manner by the pretensioning action of the leg spring 92 which is transmitted to the pressure plate 24 by means of the coupling lever element 78 or each coupling lever element 78 in order to generate the lifting movement. Uniform generation of lifting force is ensured by providing a plurality of coupling arrangements 40 of this kind so as to be distributed along the circumference, for example, at an angular distance of 120°. Of course, the arbor parts 84, 86 can also be constructed as screw bolts or can be held at the various structural component parts by pressing in, gluing in or some other secure connection. Moreover, depending on the existing movement clearance in the area of the pivotable bearing support, it is not absolutely necessary for the two axes S₁ and S₂ to be provided parallel to one another.

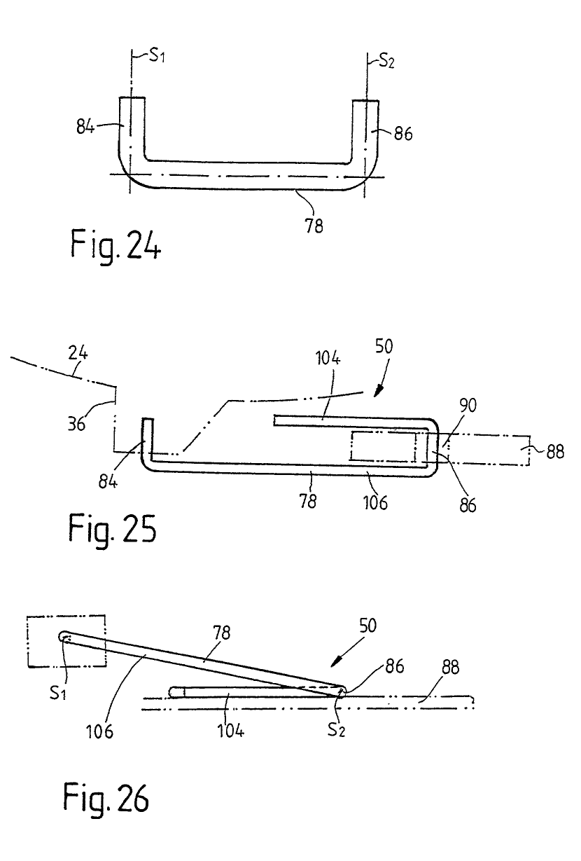

FIG. 24 shows an alternate construction of a coupling lever element 78. The arbor parts 84, 86 are formed integral with the latter or are formed, for example, by bending a corresponding wire material. In the present example, the leg spring 92 can also be supported by its spring leg 96 at an area of the coupling lever element 78 situated between the two pivot axes S₁ and S₂.

FIGS. 25 and 26 show an embodiment form in which the above-mentioned leg spring function of the lifting force generating arrangement 50 is integrated in the coupling lever element 78. It will be seen that the coupling lever element 78 with its two arbor parts 84, 86 is also formed in this case, for example, by bending a round material or wire material, preferably of spring steel material. Another leg portion 104 is provided beyond the arbor part 86 and extends away from the arbor part 86, or the material portion forming this arbor part 86, at an angle of approximately 90°. FIG. 26 shows that the coupling lever element 78 or the area 106 forming the corresponding portion, the arbor part 86 and the leg portion 104 have a U-shaped configuration, and the two U-legs, that is, portion 106 and leg portion 104, are arranged so as to be pivoted or offset relative to one another about the connecting web formed by the arbor part 86. This results in an arrangement in which the two pivot axes S₁ and S₂ are offset relative to one another in the relaxed state essentially corresponding to the release position, while the leg portion 104 contacts the area 88 of the housing 22. When the pivot axis S₁ moves downward with reference to FIG. 26 as a result of the above-described function reinforcing the pressing force, the leg spring integrated in the coupling lever element 78 is finally tensioned, as a result of which a lifting force is generated upon the subsequent release by the energy accumulator and by means of the relaxation which is then made possible.

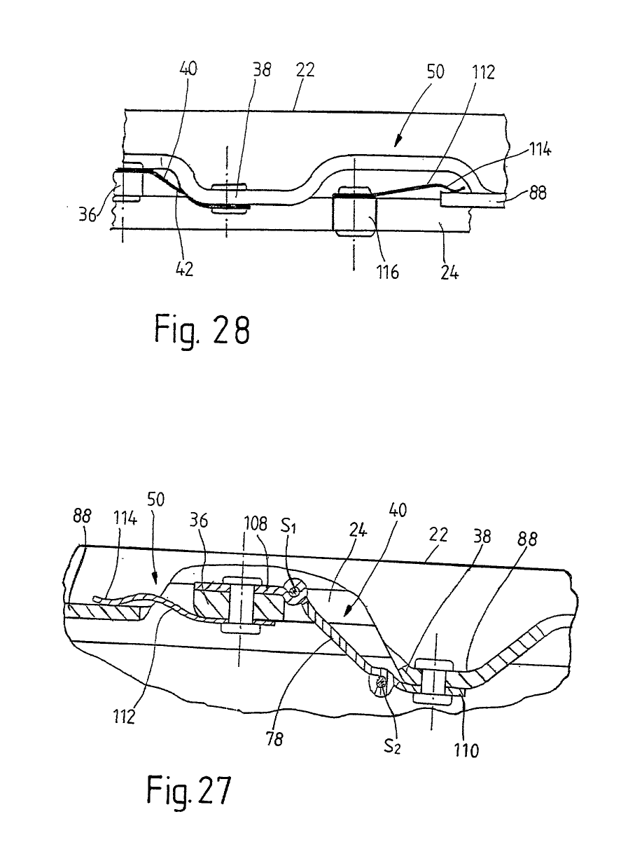

A construction according to the invention in which the coupling arrangements 40 comprise coupling lever elements 78 which are arranged at the pressure plate 24 and housing 22 so as to be pivotable about pivot axes S₁ and S₂, respectively, is also shown in FIG. 27. FIG. 27 shows a double-hinge construction in which respective hinge end parts 108, 110 are secured to the different coupling portions 36, 38 of the pressure plate 24 and housing 22 by rivet studs or the like and a hinge center part essentially forms the coupling lever element 78. A leaf spring element 112 of the lifting force generating arrangement 50 is fixedly connected, e.g., by those rivet studs by which the hinge end part 108 is also secured, with at least one, preferably a plurality of, coupling portions 36 which are arranged so as to be distributed in circumferential direction. The leaf spring element 112 extends approximately in circumferential direction and overlaps the flange-like area projecting radially outward at the side of the same remote of the flywheel. As a result of the pretensioning effect of this leaf spring element 122, or of each leaf spring element 122, a force is generated which acts so as to move the pressure plate 24 in the direction away from the flywheel and clutch disk. Since an at least slight circumferential movement of the pressure plate 24 with respect to the housing 22 must be possible, the leaf spring element 112, or each leaf spring element 112, is constructed in its free end area 114 only for supporting contact at the portion 88 of the housing 22. In this way, shear stresses or tensile stresses are prevented in a leaf spring element 122 of this kind.

The leaf spring element 112 or leaf spring elements 112 simultaneously provide(s) the function of holding the pressure plate 24 in the housing 22 before the thrust plate assembly is joined with a flywheel.

An embodiment form similar to FIG. 27 is shown in FIG. 28. It will be seen that the lifting force generating arrangement 50 again comprises a leaf spring element 112 which is supported in the free end area 114 at the portion 88 of the housing 22 which projects radially outward. This leaf spring element 112 or each leaf spring element 112 is fixedly connected with the pressure plate 24 by riveting, for example, in the area of a radial projection 116 of the pressure plate 24. The coupling arrangements 40 again comprise the leaf spring elements 42 described above which are secured to respective coupling portions 36, 38 of the pressure pate 24 and housing 22 and which are curved in axial direction. It will be seen in this embodiment form above all that the force characteristic or spring characteristic provided by the leaf spring elements 42 forming the coupling arrangements 40 is not influenced by the spring characteristic provided in the area of the lifting force generating arrangement 50. Each of these assemblies, i.e., all of these leaf spring elements 42 and 112, can accordingly be provided with an optimal spring characteristic with respect to their function. Also, in this embodiment form the leaf spring elements 112 of the lifting force generating arrangement 50 again have the function of holding the pressure plate inside the housing arrangement before the thrust plate assembly is joined with the flywheel. This is important because an excessive axial displacement of the pressure plate 24 could lead to an overloading of, and therefore damage to the leaf spring elements 42.

In an alternate embodiment form, it could also be provided, for example, that the leaf spring elements 112 shown in FIGS. 27 and 28 are not supported at the housing 22, but rather at the flywheel.

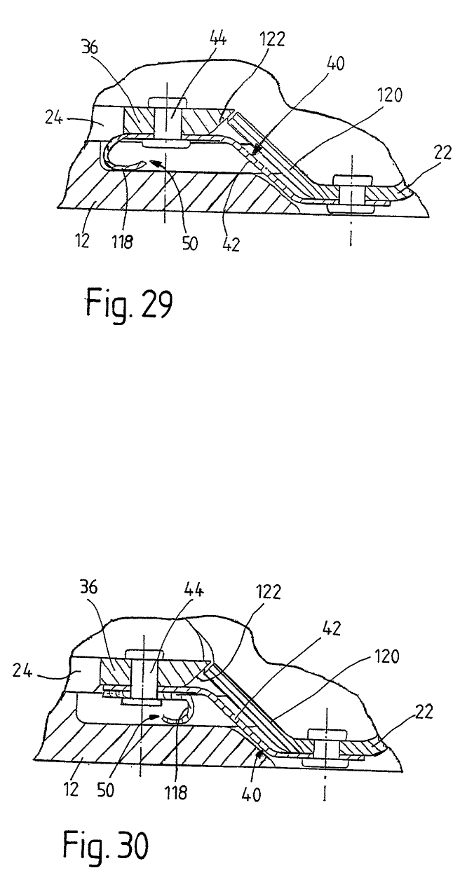

In the embodiment shown in FIG. 29, the lifting force generating arrangement 50 again comprises a leaf spring element 118. This leaf spring element 118 is formed by an area of the leaf spring element 42 or leaf spring elements 42 forming the coupling arrangements, which area extends beyond the rivet connection with the coupling portion 36 of the pressure plate 24 and does not contribute to the rotational coupling. This leaf spring portion 118 is curved and has an approximately U-shaped contour. This portion 118 is supported by one of the U-legs at the coupling portion 36 and is supported by the other U-leg at the flywheel 12 or, as the case may be, at the housing 22. Accordingly, an embodiment form is provided which is constructed in a very simple manner and in which no additional components need be provided, but in which the lifting force can nevertheless be generated independent from the spring characteristic of the respective leaf spring element 42.

In the embodiment shown in FIG. 29, a contact area 120 extending in the region of a respective coupling portion 36 is provided at the housing 22. In push operation, during which the pressure plate 24 is acted upon with respect to the housing 22 by the occurring torque in such a way that the leaf spring elements 42 are compression loaded, a respective coupling portion 36 contacts an inclined contact surface 122 at the respective contact area 120, so that further compression loading of the leaf spring elements can be prevented.

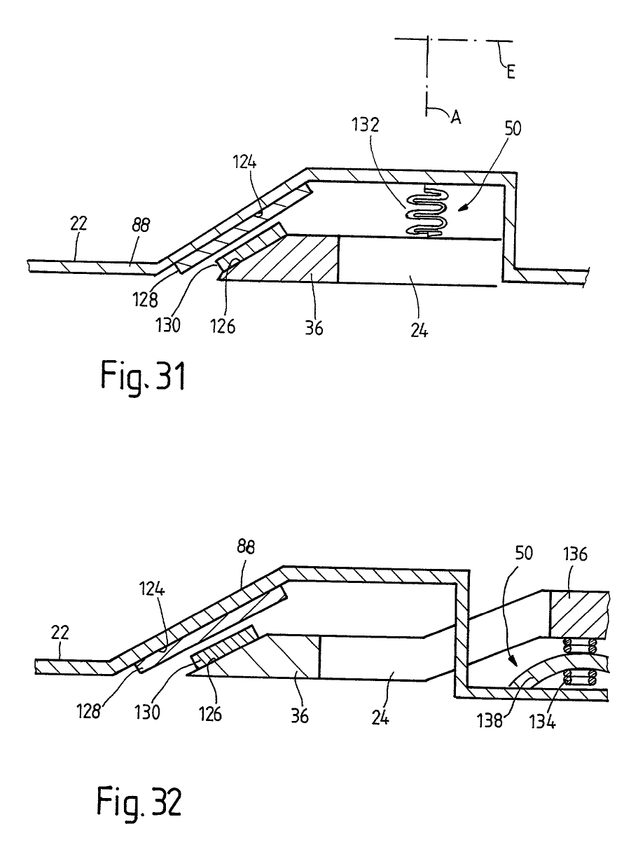

In the embodiment form shown in FIG. 30, the leaf spring portion 118 is provided as an element which is constructed separate from the leaf spring element 42 and is likewise secured to the pressure plate 24 by the rivet studs 44 which connect the leaf spring element 42 to the coupling portion 36 of the pressure plate 24.

FIGS. 31 and 32 show embodiment forms in which the pressing force reinforcing effect in the area of the coupling portions 36 projecting radially outward from the pressure plate 24 is not carried out by any deformable or pivotable coupling elements or the like, but rather by a ramp surface effect. It will be seen that a supporting surface 124 which extends at an inclination with respect to a plane orthogonal to the axis of rotation A is provided at the flange-like rim area 88 of the housing 22 which projects radially outward. A counter-support surface 126 is provided at the associated coupling portion 36 of the pressure plate 24. Further, in the present embodiment form, supporting elements 128, 130 are provided at these two surfaces 124, 126, so that the two surfaces 124, 126 do not contact one another directly, but rather via the supporting elements 128, 130. When the pressure plate 24 is pretensioned or rotated with respect to the housing 22 when torque is transmitted in pull operation such that the coupling portion 36 moves to the left with reference to the view in FIG. 31, the inclined surfaces 124, 126 and the correspondingly oriented supporting elements 128, 130 generate a force deflection with the result that the pressure plate 24 is pressed toward the flywheel in a reinforced manner.

It should be noted that the supporting elements 128, 130 can have a wide variety of different configurations. For example, they can be sliding material bodies which are displaceable relative to one another with a small sliding coefficient. It is also possible for these two supporting elements 128, 130 to be formed of permanently magnetized material and to be arranged in such a way that areas of like polarity lie opposite one another. Due to the existing repelling effect, the two supporting elements 128, 130 are displaced relative to one another completely without sliding friction while generating the pressing force reinforcing effect described above.

It will be seen that the restoring force generating arrangement 50 has one or more helical tension springs 132 arranged so as to be distributed in circumferential direction. These helical tension springs 132 are arranged at the housing 22 on one side and at the pressure plate 24 on the other side and ensure that the pressure plate 24 is pulled into the housing 22 and is accordingly moved away from the flywheel when not acted upon, or when acted upon to a lesser degree by means of the energy accumulator.

In the embodiment form shown in FIG. 32, the lifting force generating arrangement 50 comprises a helical compression spring 134 which is arranged between the flange-like area 88 of the housing 22 which projects radially outward and an associated spring projection 136 of the pressure plate 24. For purposes of securing against centrifugal force, a retaining clip 138 is provided for the helical compression spring, or for every such helical compression spring, by means of corresponding shaping at the area 88 of the housing 22 projecting radially outward, and the helical compression spring 134 can be supported toward the radial outside at the retaining clip 138. Of course, a corresponding securing against centrifugal force can also be provided for the helical tension spring, or every such helical tension spring, of the embodiment form according to FIG. 31.

The present invention provides various possibilities in a thrust plate assembly with self-reinforcing pressing force action for providing a lifting force independent from the pressing force reinforcement characteristic and material characteristic or spring characteristic of the structural component parts provided for this purpose.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A thrust plate assembly comprising
a housing,
a pressure plate,
at least one coupling arrangement coupling said pressure plate to said housing and acting axially on said pressure plate when torque is transmitted from said housing to said pressure plate,
an energy accumulator supported between said housing and said pressure plate, said energy accumulator loading said pressure plate in an engaging direction with respect to said housing, said energy accumulator having a radially outer area, and
a lifting force generating arrangement for generating a lifting force on said pressure plate in a releasing direction.

2. A thrust plate assembly as in claim 1 wherein said lifting force generating arrangement couples said pressure plate to said energy accumulator for common movement in the releasing direction.

3. A thrust plate assembly as in claim 2 wherein said lifting force generating arrangement comprises a driving arrangement at the pressure plate, said driving arrangement overlapping the radial outer area of the energy accumulator.

4. A thrust plate assembly as in claim 3 wherein said driving arrangement comprises at least one driving element which is secured to the pressure plate.

5. A thrust plate assembly as in claim 4 wherein said coupling arrangement comprises at least one leaf spring which is formed integrally with a respective said driving element.

6. A thrust plate assembly as in claim 3 wherein said driving arrangement comprises a radially inward facing undercut in said pressure plate, said radial outer area of said energy accumulator engaging in said undercut by at least one of radial expansion during assembly and rotation of said energy accumulator with respect to said pressure plate.

7. A thrust plate assembly as in claim 6 wherein said driving arrangement comprises a plurality of circumferentially arranged driving areas, each said driving area comprising radially inward facing undercut, said radially outer area of said energy accumulator comprising a plurality driver tongues which are positioned in said undercuts by rotation of said energy accumulator with respect to said pressure plate.

8. A thrust plate assembly as in claim 3 wherein said driving arrangement comprises a radially outward facing undercut in said pressure plate, said lifting arrangement further comprising at least one driver hook at said radial outer area of said energy accumulator, said driver hook which engages in said radially outward facing undercut.

9. A thrust plate as in claim 8 wherein said at least one driver hook is formed integral with the energy accumulator.

10. A thrust plate as in claim 8 wherein said lifting arrangement comprises a driver ring at said radial outer area of said energy accumular, said at least one driver hook being formed by said driver ring.

11. A thrust plate assembly as in claim 1 wherein said at least one coupling arrangement comprises at least one coupling lever element connected to said pressure plate and to said housing so as to pivot about respective pivot axes at said pressure plate and said housing, said lifting force generating arrangement pretensioning said at least one coupling lever element to pivot about at least one of said pivot axes.

12. A thrust plate assembly as in claim 11 wherein said lifting force generating arrangement comprises a spring element which pretensions said at least one coupling lever element.

13. A thrust plate assembly as in claim 12 wherein said spring element is a leg spring having a pair of spring legs, one of said spring legs being supported by said coupling lever element, the other of said spring legs being supported by one of said housing and said pressure plate.

14. A thrust plate assembly as in claim 13 wherein said spring element is integral with said at least one coupling lever element.

15. A thrust plate assembly as in claim 14 wherein said at least one coupling lever element is U-shaped and comprises a connecting web and two U-legs, one of said U-legs being pivotably connected to one of said housing and said pressure plate remote from said connecting web, the other of said U-legs being connected to the other of said housing and said pressure plate for generating a pretensioning force.

16. A thrust plate assembly as in claim 1 wherein said lifting force generating arrangement comprises at least one spring element which generates a lifting force substantially independently of said coupling arrangement.

17. A thrust plate assembly as in claim 16 wherein said at least one spring element comprises one of a helical compression spring, a helical tension spring, a leaf spring, and a scroll spring.

18. A thrust plate assembly as in claim 17 wherein said at least one coupling arrangement comprises at least one leaf spring element, and wherein said at least one spring element of said lifting force generating arrangement is formed integrally with the leaf spring element of the coupling arrangement.
